(19) United States
(12) Patent Application Publication
(10) Pub. No.: US 2005/0278954 A1
(43) Pub. Date: Dec. 22, 2005

(54) Shaving aid body for a safety razor

(75) Inventors: Glennis J. Orloff, Woodbridge, CT (US); Mark S. Peyser, Easton, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/179,757

(22) Filed: Jul. 11, 2005

Related U.S. Application Data
(63) Continuation-in-part of application No. 10/367,133, filed on Feb. 14, 2003.
(60) Provisional application No. 60/375,843, filed on Apr. 24, 2002.

(51) Int. Cl. B26B 21/00; B26B 19/44

(52) U.S. Cl. 30/32

(57) ABSTRACT

A shaving aid body for a safety razor is provided. The shaving aid body has one or more contact portions and one or more non-contact portions and has an aperture. The aperture is sized to receive a housing with one or more razor blades disposed within the housing. In some embodiments of the present shaving aid body the contact portion is contiguous with the non-contact portion and together define a convex surface. Some embodiments of the present shaving aid body include a base embedded within the body, the base having one or more features for attaching shaving aid body to the safety razor.

### CROSS-REFERENCE TO RELATED APPLICATIONS

This application is a continuation-in-part of patent application Ser. No. 10/367,133, filed on Feb. 14, 2003, incorporated herein by reference in its entirety, which claims benefit of provisional application Ser. No. 60/375,843, filed on Apr. 24, 2002.

### BACKGROUND OF THE INVENTION

1. Technical Field

This invention relates generally to shaving devices, and more specifically to shaving aid bodies for safety razors.

2. Background Information

Some modern safety razors include a disposable razor cartridge releasably coupled to a reusable handle. Other modern safety razors have a handle and a razor cartridge that are intended to be permanently coupled and disposed of as a single unit. Most razor cartridges include one or more razor blades disposed within a housing and may further include a strip of shaving aid material attached to the housing. The strip of shaving aid material typically includes one or more shaving aids (e.g., lubricating agents, drag reducing agents, depilatory agents, cleaning agents, medicinal agents, etc.) that are deposited on the skin during the act of shaving to enhance the shaving process. Generally, the volume of shaving aid contained in this strip is insufficient for use on its own and the user will use a separate shaving preparation such as shave foam or shave gel or shave cream to provide the bulk of the lubricating, drag reducing etc function with the shaving aid strip's properties only enhancing these effects.

The comfort and performance provided by a particular safety razor are critical to the commercial success of the razor assembly. Improvements that benefit razor comfort, performance, and ease of use, however significant or subtle, can have a decided impact on the commercial success of a razor assembly. For example, many consumers, especially women, find it desirable to shave within a wet shaving environment, for instance, within a shower. Unfortunately, the water within the wet shaving environment typically removes the shaving preparation before the surface can be shaved. As a result, the function performed by the shaving preparation goes unexecuted.

In the first commercial embodiment of a new type of safety razor known as Intuition™, manufactured and sold by the assignee of this Patent application, a replacement cartridge for this safety razor is provided that comprises a water soluble, erodable shaving aid body. Hereinafter, all references to Intuition™ are applicable to the first commercial embodiment of this razor. The shaving aid body of Intuition™ includes an aperture disposed in the shaving aid body that is sized to receive a housing having one or more razor blades disposed therein. The shaving aid body has a contact portion that contacts a plane when an unused shaving aid body is placed in contact therewith and a non-contact portion that does not contact the plane when an unused shaving aid body is placed in contact therewith. The unused shaving aid body has a projected area defined as the area of the contact portion and the area of the non-contact portion each projected onto a plane defined by the highest three points of the contact portion and excluding the area of the aperture projected onto the same plane. The contact portion has a contact area defined as the area of the contact portion projected onto the same plane as described above and excluding the area of the aperture projected onto the same plane. During use, the contact portion of the shaving aid body erodes and the plane through the highest three points of the contact portion changes position. The cutting edges of the one or more razor blades are maintained in approximately coincident relationship with this plane by means of a self-leveling mechanism within the handle. The self-leveling mechanism of the Intuition™ handle is disclosed in U.S. patent application Ser. No. 10/367,255 to Pennella et al, commonly assigned herewith and hereby incorporated in its entirety by reference. The projected area of the unused shaving aid body of Intuition™ is approximately 928 mm². The contact portion of Intuition has a projected area of approximately 496 mm². As the contact portion of the Intuition™ shaving aid body is substantially flat, the highest three points that define the plane may be selected at any position on the contact portion. As the contact portion of the Intuition™ shaving aid body is substantially flat, the rate of erosion of shaving aid from the shaving aid body and deposition onto the skin of the user is high and, for a new user of this razor, can initially provide excess lubrication or drag reduction. What is needed for a new user is a ‘learning curve’ where the rate of deposition of shaving aid is initially low, but increases to the full rate relatively quickly so this will not deter an experienced Intuition™ user.

The Intuition™ safety razor includes a housing, with razor blades disposed therein, that is pivotally coupled to the handle. The shaving aid body of Intuition™ is not pivotally coupled to the handle. U.S. patent application Not Yet Assigned to Bunnell et al, commonly assigned herewith and hereby incorporated in its entirety by reference discloses a shaving aid body that is pivotally coupled to a handle. The Bunnell device requires a shaving aid body having a contact portion and non-contact portion that are optimized for use when pivotally coupled to a handle but will not deter a user when coupled to an Intuition™ handle.

Therefore, there is a need in the art to provide a shaving aid body for a safety razor wherein the rate of deposition of shaving aid on to the skin of the user increases with use. In a second aspect of the present invention, there is a need in the art to provide a shaving aid body that is optimized for use when pivotally coupled to a handle.

### SUMMARY OF THE INVENTION

The shaving aid body of the present invention, in its unused condition, comprises at least one contact portion and at least one non-contact portion. The shaving aid body also has an aperture sized to receive a housing having one or more razor blades disposed within the housing. The highest three points of the contact portion define a plane. The shaving aid body has a projected area defined as the area of the contact portion together with the area of the non-contact portion projected onto the plane and excluding the area of the aperture projected onto the plane. The contact portion has a contact area defined as the area of the contact portion projected onto the plane as described above and excluding the area of the aperture or any portion of the aperture positioned in the contact portion and projected onto the plane. The contact area is no more than 50% of the projected area of the shaving aid body. Preferably the projected area of the shaving aid body is substantially oval shaped.

In a further embodiment of the present invention, the contact portion and non-contact portion are contiguous and define a convex surface. The convexity preferably defines a radial dimension.

The shaving aid body is preferably water soluble and erodes during use. The shaving aid body provides considerable utility when used with the handle of a safety razor assembly that allows the position of the one or more razor blades in the housing to remain approximately coincident to the plane of the highest three points of the contact portion as the shaving aid body erodes. The present shaving aid body is not limited to such applications, however.

These and other objects, features, and advantages of the present invention will become apparent in light of the detailed description of the present invention.

### BRIEF DESCRIPTION OF THE DRAWINGS

FIG. 1 is an isometric view from above of the shaving aid body of the present invention.

FIG. 2 is a sectional view along line 2-2 of FIG. 1.

FIG. 3 is a view of the present invention parallel to the plane of the highest three points of the contact portion.

FIG. 4 is a view of a second aspect of the present invention parallel to the plane of the highest three points of the contact portion.

FIG. 5 is a view of a third aspect of the present invention parallel to the plane of the highest three points of the contact portion.

FIG. 6 is a sectional view of a second embodiment of the present invention taken at the same position as FIG. 2.

FIG. 7 is a sectional view of a further aspect of the embodiment of FIG. 6 taken at the same position as FIG. 2.

FIG. 8 is a front view of a second embodiment of the present invention, normal to the plane of the highest three points of the contact portion.

FIG. 9 is a view of the embodiment of FIG. 8 parallel to the plane of the highest three points of the contact portion.

FIG. 10 is a front view of a third embodiment of the present invention, normal to the plane of the highest three points of the contact portion.

FIG. 11 is a view of the embodiment of FIG. 10 parallel to the plane of the highest three points of the contact portion.

FIG. 12 is a front view of a fourth embodiment of the present invention, normal to the plane of the highest three points of the contact portion.

FIG. 13 is a view of the embodiment of FIG. 12 parallel to the plane of the highest three points of the contact portion.

FIG. 14 is an isometric view from above of the shaving aid body of the present invention coupled the handle of a safety razor assembly.

### DETAILED DESCRIPTION OF THE INVENTION

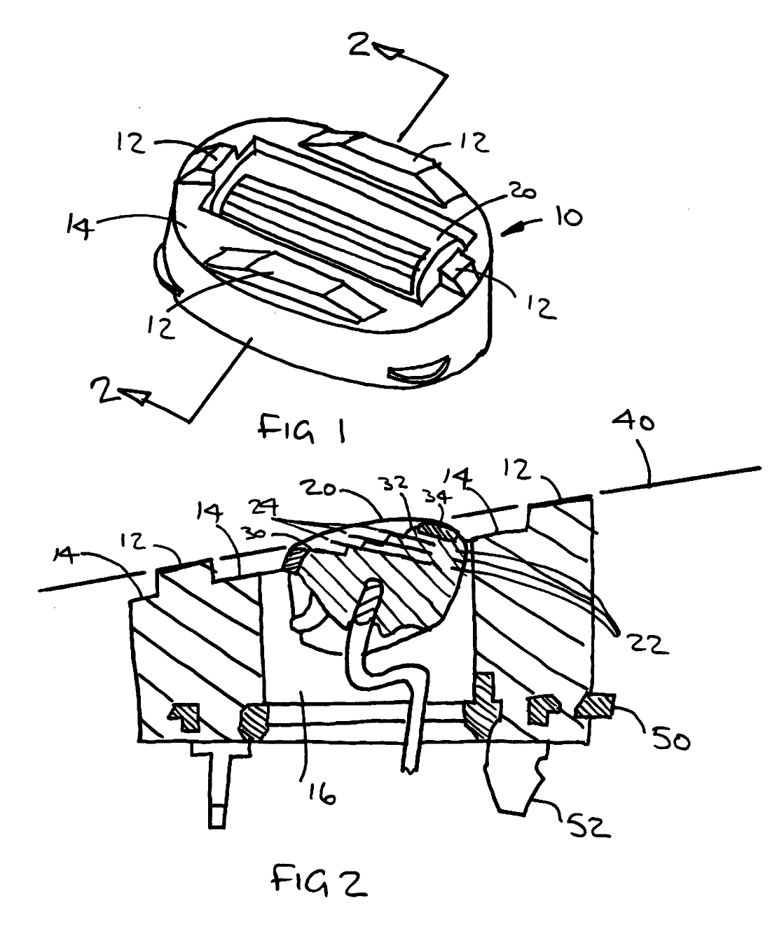

Referring to FIGS. 1-5, a shaving aid body 10 for use with a safety razor (not shown in these figs), in its unused condition, includes a contact portion 12 and a non-contact portion 14. The shaving aid body further comprises an aperture 16 sized to receive a housing 20. The housing has one or more razor blades 22, each having a cutting edge 24, disposed therein. The housing may further comprise a guard 30, a cap 32 and a shaving aid strip 34. A plane 40 is defined as being through the highest three points of the contact portion. The cutting edges of the razor blades are approximately coincident with the plane. The shaving aid body has a base 50 embedded within it. The base has one or more features 52 for coupling the shaving aid body to a safety razor.

The shaving aid body is preferably an erodable solid body consisting of a shaving aid material that is selected to suit the application at hand. A solid soap-type shaving aid material is particularly well suited for wet shaving applications, but other shaving aid materials (e.g., lubricating agents, drag reducing agents, depilatory agents, cleaning agents, medicinal agents, sensory agents, skin stimulation agents, etc.) can be used alternatively, or in some combination thereof.

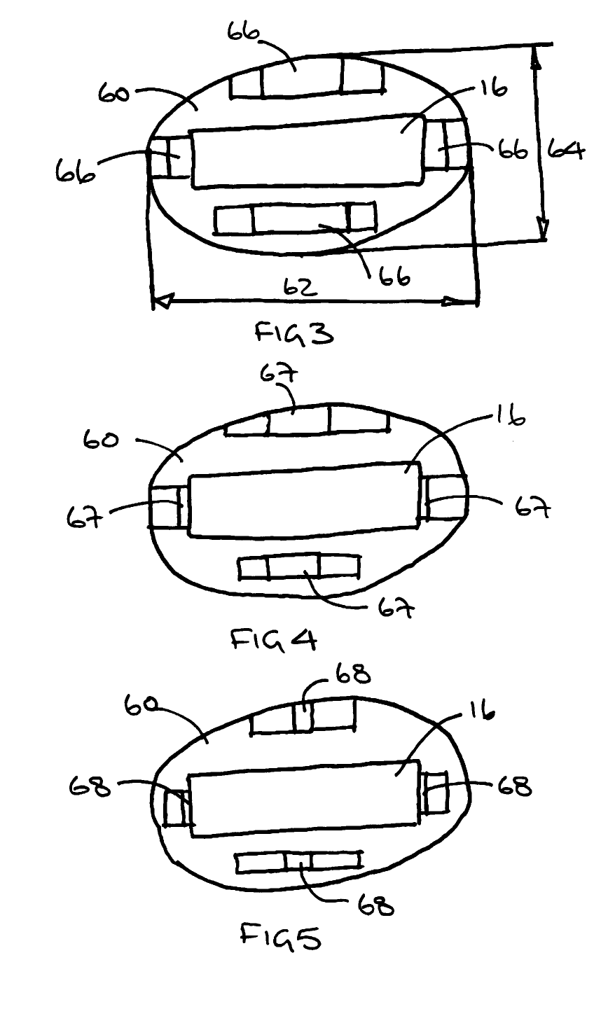

Referring to FIG. 3, the contact portion and non-contact portion of the shaving aid body define a projected area 60 projected onto plane 40. The projected area is preferably substantially oval shaped as shown in this figure and the oval shape has a length 62 and width 64. The length is defined as the maximum dimension of the projected area of the shaving aid body parallel to the cutting edge 24. The width is defined as the maximum dimension of the projected area of the shaving aid body perpendicular to the length. The surface area of the projected area excludes the area of the aperture 16 projected onto the same plane. The length is preferably greater than the width. The contact portion has a contact area 66 projected onto the same plane. The total contact area is not more than 50% of the projected area of the shaving aid body. As the shaving aid body erodes during use the contact area will increase. Theoretically, after some use, the contact area will equal 100% of the projected area. However one of skill in the art will understand that the actual proportion of the contact area of a used shaving aid body relative to the projected area is dependent upon the shaving habits of individual users. FIGS. 4 and 5 are views of further aspects of the present invention in the same direction as FIG. 3. In FIG. 4, the total contact area of the contact portion 67 is not more than 20% of the projected area of the shaving aid body. In FIG. 5, the total contact area of the contact portion 68 is not more than 10% of the projected area of the shaving aid body.

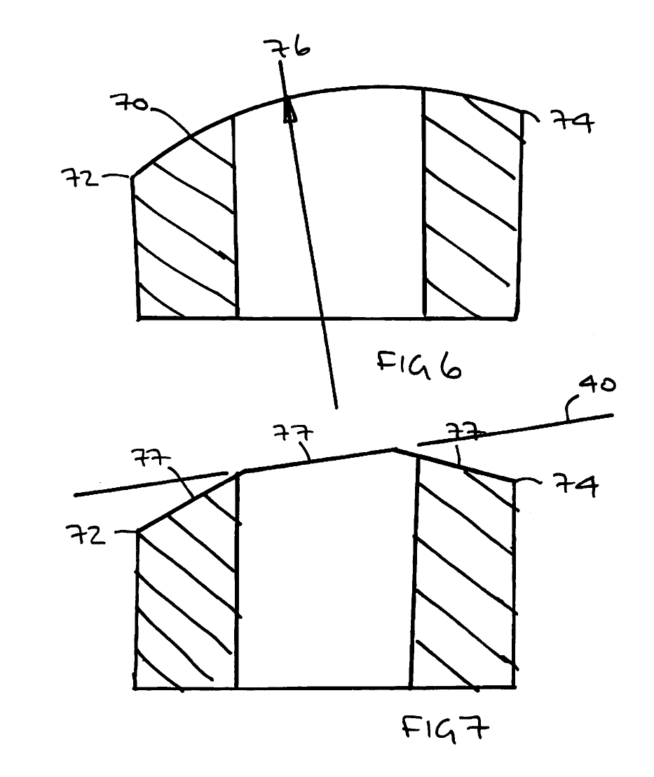

Referring now to FIG. 6, a second embodiment is shown in sectional view parallel to the width. The contact portion and non-contact portion are contiguous and define a convex surface 70. It is important to understand that the word “convex” as used in the present specification does not necessarily mean that the surface is smoothly curved. It implies only that the surface extends upwards from its extreme edges 72, 74 to the plane of the highest three points of the contact portion. The convexity preferably defines a radial dimension, 76 of at least 15 mm and more preferably about 26 mm. Referring now to FIG. 7, a further aspect of the embodiment of FIG. 6 is shown where the convex surface, 77 is not smoothly curved.

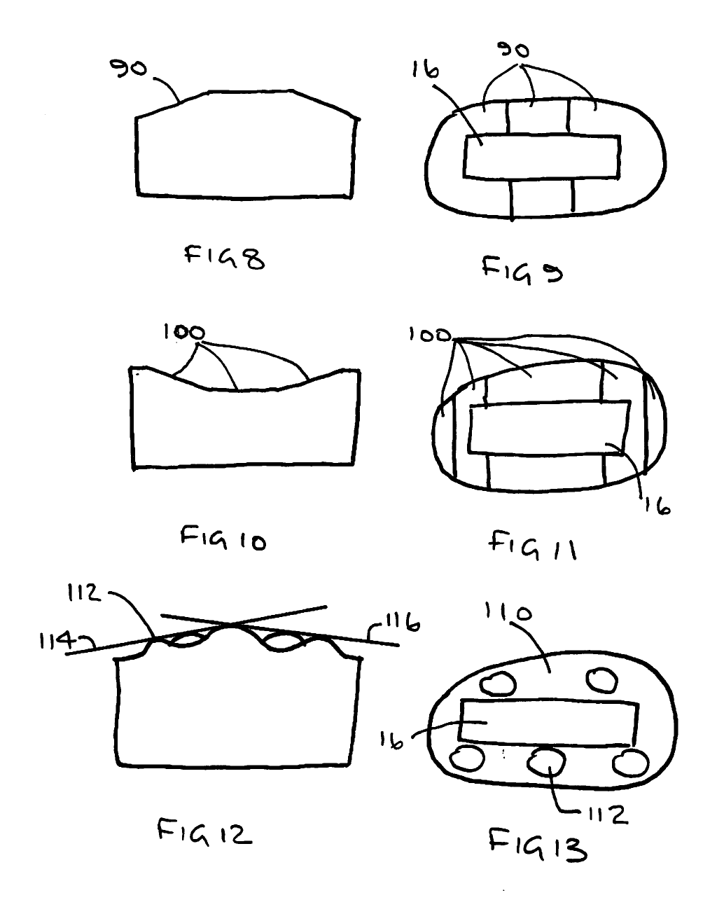

Referring now to FIGS. 8-9, a third embodiment of the shaving aid body of the present invention is shown in views, respectively, of the front of the shaving aid body, normal to the plane of the three highest points of the contact portion and parallel to the plane as previously described. The contact portion and non-contact portion are contiguous and define a convex surface 90.

Referring now to FIGS. 10-11, a fourth embodiment of the shaving aid body of the present invention is shown in views, respectively, of the front of the shaving aid body, normal to the plane of the three highest points of the contact portion and parallel to the plane as previously described. The contact portion and non-contact portion are contiguous and define a concave surface 100.

Referring now to FIGS. 12-13, a fifth embodiment of the shaving aid body of the present invention is shown in views, respectively, of the front of the shaving aid body, normal to the plane of the three highest points of the contact portion and parallel to the plane as previously described. The contact portion and non-contact portion are contiguous and define a surface 110 having more than one peak 112. In instances where the shaving aid body has four or more peaks it may be possible to define more than one plane 114, 116 through three highest points. For the purposes of defining contact area and projected area of the shaving aid body, these areas shall be defined relative to all possible planes through three highest points.

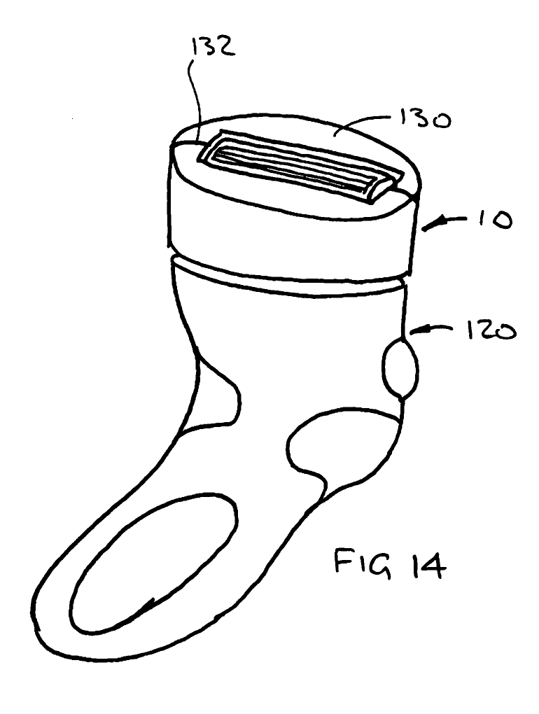

Referring now to FIG. 14, a safety razor 120 is shown having a shaving aid body 10 coupled thereto. The contact portion and non-contact portion of the shaving aid body are contiguous and define a convex surface 130. The convexity preferably defines an arc 132 parallel to the length, having a radius of at least 35 mm and more preferably about 65 mm.

Although the present invention has been described in considerable detail with reference to certain preferred versions thereof, other versions are possible. Therefore, the spirit and scope of the invention should not be limited to the description of the preferred versions contained herein.

1. A shaving aid body for a safety razor, in its unused condition, comprising:
at least one contact portion and at least one non-contact portion; and an aperture disposed in the shaving aid body;
wherein the aperture is sized to receive a housing having one or more razor blades disposed therein;
wherein the highest three points of the contact portion define a plane;
wherein the shaving aid body has a projected area defined as the area of the contact portion and the area of the non-contact portion projected onto the plane and excluding the area of the aperture projected onto the plane;
wherein the contact portion has a contact area defined as the area of the contact portion projected onto the plane and excluding the area of the aperture or portion thereof positioned in the contact portion and projected onto the plane; and
wherein the contact area is not more than 50% of the projected area of the shaving aid body.

2. A shaving aid body according to claim 1, wherein the contact area is not more than 20% of the projected area.

3. A shaving aid body according to claim 1, wherein the contact area is not more than 10% of the projected area.

4. A shaving aid body according to claim 1, wherein the projected area has a length and a width and the length is greater than the width.

5. A shaving aid body according to claim 4, wherein the projected area is substantially oval shaped.

6. A shaving aid body according to claim 4, wherein the contact portion and the non-contact portion are contiguous and define a surface, the surface being convex in a direction parallel to the length and normal to the plane.

7. A shaving aid body according to claim 6, wherein the convexity defines an arc having a radius of at least 35 mm.

8. A shaving aid body according to claim 6, wherein the convexity defines an arc having a radius of about 65 mm.

9. A shaving aid body according to claim 4, wherein the contact portion and the non-contact portion are contiguous and define a surface, the surface being convex in a direction parallel to the width and normal to the plane.

10. A shaving aid body according to claim 9, wherein the wherein the convexity defines an arc having a radius of at least 15 mm.

11. A shaving aid body according to claim 9, wherein the convexity defines an arc having a radius of about 26 mm.

12. A shaving aid body according to claim 4, wherein the contact portion and the non-contact portion are contiguous and define a surface, the surface being convex in a direction parallel to the width and normal to the plane and convex in a direction parallel to the width and normal to the plane.

13. A shaving aid body according to claim 4, wherein the contact portion and the non-contact portion are contiguous and define a surface, the surface being concave in a direction parallel to the length and normal to the plane.

14. A shaving aid body according to claim 4, wherein the contact portion and the non-contact portion are contiguous and define a surface, the surface being concave in a direction parallel to the width and normal to the plane.

15. A shaving aid body according to claim 4, wherein the contact portion and the non-contact portion are contiguous and define a surface, the surface being concave in a direction parallel to the length and normal to the plane and concave in a direction parallel to the width and normal to the plane.

16. A shaving aid body according to claim 4, wherein the contact portion and the non-contact portion are contiguous and define a surface, the surface having more than one peaks in a direction parallel to the width and normal to the plane.

17. A shaving aid body according to claim 5, wherein the contact portion and the non-contact portion are contiguous and define a surface, the surface being convex in a direction parallel to the length and normal to the plane.

18. A shaving aid body according to claim 17, wherein the convexity defines an arc having a radius of at least 50 mm.

19. A shaving aid body according to claim 17, wherein the convexity defines an arc having a radius of about 65 mm.

20. A shaving aid body according to claim 5, wherein the contact portion and the non-contact portion are contiguous and define a surface, the surface being convex in a direction parallel to the width and normal to the plane.

21. A shaving aid body according to claim 20, wherein the wherein the convexity defines an arc having a radius of at least 15 mm.

22. A shaving aid body according to claim 20, wherein the convexity defines an arc having a radius of about 26 mm.

23. A shaving aid body according to claim 5, wherein the contact portion and the non-contact portion are contiguous and define a surface, the surface being convex in a direction parallel to the width and normal to the plane and convex in a direction parallel to the width and normal to the plane.

24. A shaving aid body according to claim 5, wherein the contact portion and the non-contact portion are contiguous and define a surface, the surface being concave in a direction parallel to the length and normal to the plane.

25. A shaving aid body according to claim 5, wherein the contact portion and the non-contact portion are contiguous and define a surface, the surface being concave in a direction parallel to the width and normal to the plane.

26. A shaving aid body according to claim 5, wherein the contact portion and the non-contact portion are contiguous and define a surface, the surface being concave in a direction parallel to the length and normal to the plane and concave in a direction parallel to the width and normal to the plane.

27. A shaving aid body according to claim 5, wherein the contact portion and the non-contact portion are contiguous and define a surface, the surface having more than one peaks in a direction parallel to the width and normal to the plane.

28. A shaving aid body according to claim 1, wherein the shaving aid body has a base embedded within the shaving aid body.

29. A shaving aid body according to claim 28, wherein the base includes one or more features for coupling the shaving aid body to a safety razor.

30. A safety razor assembly, comprising:
a handle;
a housing releasably coupled to the handle, the housing having one or more razor blades disposed within the housing; and
a shaving aid body releasably coupled to the handle, the shaving aid body in its unused condition comprising:
at least one contact portion and at least one non-contact portion; and an aperture disposed in the shaving aid body;
wherein the aperture is sized to receive the housing;
wherein the highest three points of the contact portion define a plane;
wherein the shaving aid body has a projected area defined as the area of the contact portion and the area of the non-contact portion projected onto the plane and excluding the area of the aperture projected onto the plane;
wherein the contact portion has a contact area defined as the area of the contact portion projected onto the plane and excluding the area of the aperture or portion thereof positioned in the contact portion and projected onto the plane; and
wherein the contact area is not more than 50% of the projected area of the shaving aid body.

31. A safety razor according to claim 30, wherein the shaving aid body is pivotally coupled to the handle.

32. A safety razor according to claim 31, wherein the projected area is substantially oval shaped.

33. A safety razor according to claim 32, wherein the contact portion and the non-contact portion are contiguous and define a surface, the surface being convex in a direction parallel to the width and normal to the plane.

34. A safety razor according to claim 33, wherein the convexity defines an arc having a radius of about 65 mm.
